(19) United States
(12) Patent Application Publication
(10) Pub. No.: US 2004/0243343 A1
(43) Pub. Date: Dec. 2, 2004

(54) Monitoring system with an integrated toolkit

(76) Inventors: Alastair John Nelson, Teddington (GB); Timothy Callahan, Sparta, NJ (US); Paul Smithies, Somerville, NJ (US); David Arthur Spingarn, Randolph, NJ (US); Harold J. Carlson, Newton, NJ (US); Richard H. Lander, Berkeley Heights, NJ (US)

Correspondence Address: Paul D. Greeley, Esq., Ohlandt, Greeley, Ruggiero & Perle, L.L.P., One Landmark Square, 10th Floor, Stamford, CT, 06901-2682, US

(21) Appl. No.: 10/383,832

(22) Filed: Mar. 7, 2003

Related U.S. Application Data
(60) Provisional application No. 60/362,974, filed on Mar. 8, 2002.

(51) Int. Cl. G06F 15/00

(52) U.S. Cl. 702/182

(57) ABSTRACT

A monitoring system is provided for monitoring business and financial information. A user creates a customer application from a downloadable data integration toolkit. The user subscribes to a monitoring service by registering a set of cases. Then, the user requests notifications, including notifications that contain data products that are directly insertable into the user's database system. The monitoring service is uniform for all businesses globally.

### CROSS REFERENCE

This application claims priority of U.S. Provisional Patent Application Serial No. 60/362,974, filed on Mar. 8, 2002, entitled “System for High Level Business Requirements for Alert/Monitoring Services.”

### BACKGROUND

1. Field of the Invention

The present invention relates to data processing and information services, and more particularly, to providing a monitoring service for business and financial information.

2. Description of the Related Art

A data integration toolkit, sold by Dun & Bradstreet Corporation, Short Hills, N.J., includes a set of software components that enable users to build their own customer interfaces to a business and financial information system for timely access to data from around the world. A server and a client based on the data integration toolkit together form an information system.

A deficiency of the information system is that it lacks a monitoring system. As a result, many users have created their own custom interfaces with work-around patches. These work-around patches typically allow registration of a user's cases in a separate, existing monitoring system on behalf of the user. After changes occur, a file is forwarded to the user that contains all identification numbers of the user's cases that have changed since the prior report. Thereafter, the user uses this to create an order for a product. Unfortunately, this was a semi-manual system.

The user requires an alert and monitoring service for two reasons. First, the user is often a credit insurer, who needs a current database in order to assess the risk exposure to any given company, sector, or customer. Second, the user wants to reduce transaction times.

One problem of the work-around patches is that each region throughout the world has a different monitoring system, which does not provide for ready integration with the globally enabled product ordering fabrication and delivery system. Because a purpose of the system is to provide a fully integrated financial and business information system throughout the world, it does not make sense to have a different monitoring system for each region of the world from which they choose to receive financial and business data.

Thus, segmented, semi-manual work-around patches are unattractive. First, an integration solution is needed. Hence, the user does not want to have to deal with monitoring in a different way in different parts of the world. Second, the system is supposed to provide globally consistent data available through one service. From the customer's point of view, a monitoring service should work in the same way for all parts of the world.

It is highly desirable to provide an integrated, monitoring system. This would provide users with the ability to receive global, timely financial and business information, which the customer can then use to determine credit worthiness or other useful information. By obtaining this information through a monitoring system, the customer need not frequently pull products about businesses which may or may not have experienced change. Rather, only the change information is obtained. This greatly reduces the volume of data to be transmitted and processed by the customer.

The easy integration of an alert and monitoring system with a user's own automated processes would speed up development time and, after the system is up and running, free up valuable resources due to minimized manual intervention.

### SUMMARY OF THE INVENTION

A method for providing a monitoring service and a monitoring system with an integrated toolkit are described herein.

One embodiment of the present invention is a method of providing a monitoring service. An add registration request is received from a customer application to register a case for a user. The add registration request is authorized by checking a user profile associated with the customer application for access. The add registration request comprises a case identification number, a data product name, and a notification level. The case identification number is validated. A response is sent to the customer application indicating a pending registration status, before the case is registered. The case is registered by storing baseline data for the case and setting a registration status for the case to active. The user is charged for the add registration requests once they are successfully activated. Additional add registration requests are received from the customer application to register additional cases and a portfolio of cases is created by registering each of the additional cases in the portfolio.

A registered case is monitored by detecting data changes and providing a notification of those data changes. The registered case is monitored by receiving an update on a subject and determining that the subject is part of the registered case, and then storing update data for the subject for future notification delivery.

A notification is provided after receiving a notification request from the customer application. The notification request comprises the case identification number, the data product name, and the notification level. A notification is fabricated based on the update data and made available to the customer application. The notification level may be one, two, or three. If the notification level is one, then notification comprises a tag of an element that has changed. If the notification level is two, then the notification comprises a tag of an element that has changed and the new value of the field. If the notification level is three, then the notification comprises a tag of an element that has changed, the new value of the field, and a data product. Where multiple elements have changed for a case with notification level three, they are delivered together so that only one data product is fabricated.

There are several other requests in addition to the notification request. If a get-registration request is received from the customer application, then information is provided about the registered case, if it matches criteria in the request, such as a registration status. If a registration activity request is received from the customer application, then information is provided about the registered case if it matches criteria in the request. If a modify registration request is received from the customer application, then the case is modified according to a modification instruction in the request. The modify registration request comprises the case identification number, the data product name, the notification level, and the modification instruction. If a cancel registration request is received from the customer application, then the registration status is changed to cancelled and the cancellation is confirmed to the customer application. The cancel registration request comprises the case identification number, the data product name, and the notification level. If a reverse registration cancellation request is received from the customer application, then the registration status is changed to active and the cancellation reversal is confirmed to the customer application. The reverse registration cancellation request comprises the case identification number, the data product name, and the notification level. If a registration transfer request is received from the customer application to transfer from a current owner to a new owner, then ownership of the registered case is transferred from the current owner to the new owner and confirmed to the customer application. The registration transfer request comprises current owner login information and new owner login information. The current owner login information and the new owner login information are authorized by checking profiles for access. It is verified that the current owner and the new owner have the some of the same billing information.

In addition to requests, there are notices that are received. If notice of a deleted case identification number is received, the registration status is changed to deactivated for the case and a registration activity notification is made available to the customer application, if it is the same as the deleted case identification number. If notice of reinstatement of a previously deactivated case is received, then registration status for the case is changed to active, if the case identification number is the same as the reinstated case identification number included in the notice of reinstatement. If a stop distribution information for a subject is received, then a subject status is changed to unavailable and any notifications for the subject are put on hold if the subject is part of the registered case.

Another embodiment of the present invention is a website comprising a downloadable data-integration toolkit for communicating with a monitoring system for monitoring changes to business and financial information. The downloadable data-integration toolkit comprises a plurality of downloadable software components for building a customer application and a plurality of request formats for use by said customer application in communicating with said monitoring system. The plurality of request formats comprise formats for an add registration request, a modify registration request, a registration transfer request, a registration activity request, a get-registration request, and a get-notification request. The website also comprises instructions for communications from said customer application to the monitoring system.

Another embodiment of the present invention is a monitoring system. The monitoring system comprises a web server, a global service gateway, a monitoring engine, a data repository, a monitoring database, and a data manager. The web server is capable of receiving a request from a customer application and sending a notification to the customer application. The global service gateway is capable of fulfilling the request and fabricating the notification. The monitoring engine is capable of detecting a data change and providing the data change for a subject with an active registration to the global service gateway for use in fabricating the notification. The data repository is capable of providing a change indication to the monitoring engine. The monitoring database is capable of storing registration information and providing baseline data to the monitoring engine. The data manager is capable of providing update data to the monitoring engine and providing data to the global service gateway for use in fabricating the notification. In some cases, the notification includes a data product.

The monitoring system may also comprise a downloadable data-integration toolkit, a customer service center, a datamart, a billing system, an inter-regional gateway, a global data access component, and a business data cache. The downloadable data-integration toolkit is for facilitating creation of the customer application. The customer service center is capable of performing as a more power customer application and across registrations for multiple customers. The datamart is built from a global data repository to provide data to the data manager. The billing system is capable of charging a user for the customer request. The monitoring engine provides information to the billing system based on the registration information and the request. The inter-regional gateway is capable of accessing a plurality of data centers in various regions. The global data access component is capable of receiving business and financial data from the inter-regional gateway and providing the business and financial data to the data manager. The business data cache is capable of storing data associated with the data change for use in fabricating the notification and providing the data to the data manager.

These and other features, aspects, and advantages of the present invention will become better understood with reference to the following drawings, description, and appended claims.

### BRIEF DESCRIPTION OF THE DRAWINGS

FIG. 1 is a block diagram of a customer application communicating with a monitoring system according to the present invention.

FIG. 2 is an architecture diagram of the monitoring system of FIG. 1 according to the present invention.

FIG. 3 is another architecture diagram of a monitoring system according to the present invention, shown in more detail than FIG. 2.

FIG. 4 is a context diagram of methods for providing a monitoring service according to the present system in a monitoring system, such as the one shown in FIGS. 2 and 3.

### DETAILED DESCRIPTION OF THE PREFERRED EMBODIMENTS

In the following detailed description, reference is made to the accompanying drawings. These drawings form a part of this specification and show by way of example specific preferred embodiments in which the present invention may be practiced. These embodiments are described in sufficient detail to enable those skilled in the art to practice the present invention. Other embodiments may be used. Structural, logical, and electrical changes may be made without departing from the spirit and scope of the present invention. Therefore, the following detailed description is not to be taken in a limiting sense and the scope of the present invention is defined only by the appended claims.

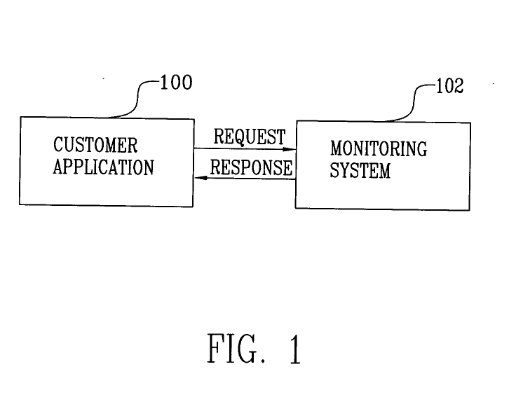

FIG. 1 shows a customer application 100 communicating with a monitoring system 102 according to the present invention. Customer application 100 sends a request to monitoring system 102 and monitoring system 102 sends a response back to customer application 100. Customer application 100 is built from a data integration toolkit, which is downloadable from a website. The data integration toolkit enables a user to build and implement enterprise-wide access to business information so that business decisions are made more easily and efficiently. Timely data is delivered directly into the user's system or applications and increases the speed and accuracy of decision making so that business transactions are more streamlined and strategic, ultimately giving the user an edge over the competition and increased profit over time.

The data integration toolkit is a web-based set of software components for building the user's own interface to monitoring system 102 customized to the user's own requirements simply and quickly. Because the data integration toolkit uses industry standard Internet technology, such as extensible markup language (XML), Java, and component object model (COM), it can reduce the time it takes to complete projects and lower the cost of development significantly.

Containing pre-developed code, the user's development teams can use the data integration toolkit to interface with monitoring system 102 more quickly than ever before. The user simply downloads the data integration toolkit directly from a website along with technical documentation. The data integration toolkit reduces development costs by implementing applications quickly. The user controls system design based on its needs. The user improves productivity and increases the consistency and accuracy of decisions across its entire organization. Business performance is increased and valuable resources are freed up. Monitoring data can be built into business-to-business (B2B) applications, giving businesses the confidence to trade. Support groups are provided to help the user throughout the process.

Using its own unique application to interface with monitoring system 102, the user is able to access globally consistent data from around the world via one unified global platform. Data integration products and reports enable the user to minimize local and regional differences. Furthermore, in response to requests from customers, more local data is available in a number of countries to increase the depth of information delivered on a business.

Designed specifically for integration, the user selects just the information the user needs to perform data monitoring along with other functions from simple business verification to more complex vendor management activities to the planning and execution of highly targeted marketing campaigns or the development of a consistent decision strategy. Users access detailed descriptions of data integration products and reports and view samples of them on the website.

Data monitoring helps a user to maintain the integrity of its information and ensure that the user is always basing decisions on the very latest data available. Globally available data integration products are monitored for change and the updated data is made directly available to the user's systems quickly and simply so that the user controls the time and frequency of data integration. Furthermore, the process is based on data designed for integration without manual intervention, so a whole ledger can be monitored automatically, rather than just the high-risk cases.

Data monitoring is structured so that the user maintains control. The user adds, modifies, and deletes businesses from a data monitoring portfolio easily using specially designed functions and chooses how to handle the changes the user receives, integrating them directly into the user's own workflows and systems, saving valuable time and resources.

The user selects the most appropriate data integration product and level of notification for each business the user wishes to monitor according to its own processes. When a change occurs, a notification is fabricated according to the level of notification. Level 3 delivers all of the information from the user's chosen product for direct integration into the user's process or systems. Level 3 is for applications designed to accept a complete record when something changes. Level 2 delivers only those data elements that have changed. This allows quick integration of the relevant data and is ideal for systems where individual elements can be updated. Level 1 delivers a notification informing the user of which data elements have changed. This allows the user to order the appropriate product for that business or choose to take no action if the change is not critical. The following data products, which are available from Dun & Bradstreet, may be monitored: enterprise management, vendor management, financial standing, decision support, delinquency score, global failure risk score, quick check, business verification, and additional data products.

The data integration toolkit is downloadable from the website along with documentation including example code in various programming languages, sample applications, and detailed application programming interface (API) specifications, clearly outlining the object model and relationships.

For the first time, customers are able to monitor across different geographical regions using just one service. The 26 countries or areas currently covered support 99% of customer needs. The 26 countries are Andorra, Australia, Austria, Belgium, Canada, Denmark, Finland, France, Germany, Hong Kong, Ireland, Italy, Japan, Luxembourg, Monaco, Netherlands, New Zealand, Norway, Portugal, San Marino, Singapore, Spain, Sweden, Taiwan, United Kingdom and United States of America. Information is delivered in a choice of languages, including English, Dutch, French, German, Italian, Portuguese and Spanish. Other countries may also be included in the present invention.

Upon registering a business for data monitoring, a fee is charged that covers the registration for one year. A user may subsequently cancel a registration so that the user does not receive unwanted notifications. If the user decides to re-activate a registration prior to a renewal date, monitoring is re-established until the original renewal date without any additional charge.

There are many different types of monitoring transactions, such as add registration, modify registration, transfer registration, get registration list, and get registration activity list. All data monitoring transactions are stand-alone transactions, i.e., they are designed for a single purpose and are not bundled into any other transaction.

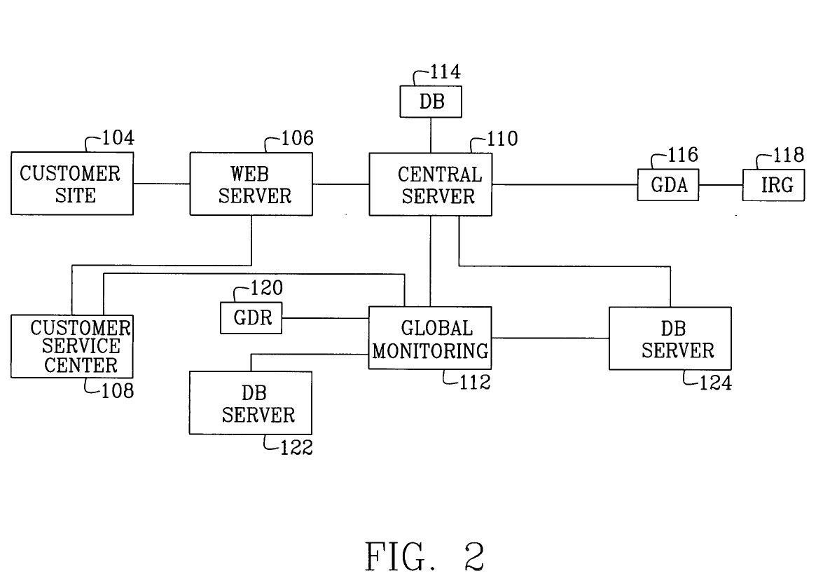

FIG. 2 shows the architecture of a monitoring system according to the present invention. A customer site 104 communicates with a web server 106. Web server 106 communicates with a central server 110. Central server 110 also communicates with a database 114 and a global data access component (GDA) 116. Global data access component 116 communicates with an inter-regional gateway (IRG) 118. A global monitoring component 112 communicates with a global data repository (GDR) 120, a customer service center 108, and database servers 122 and 124.

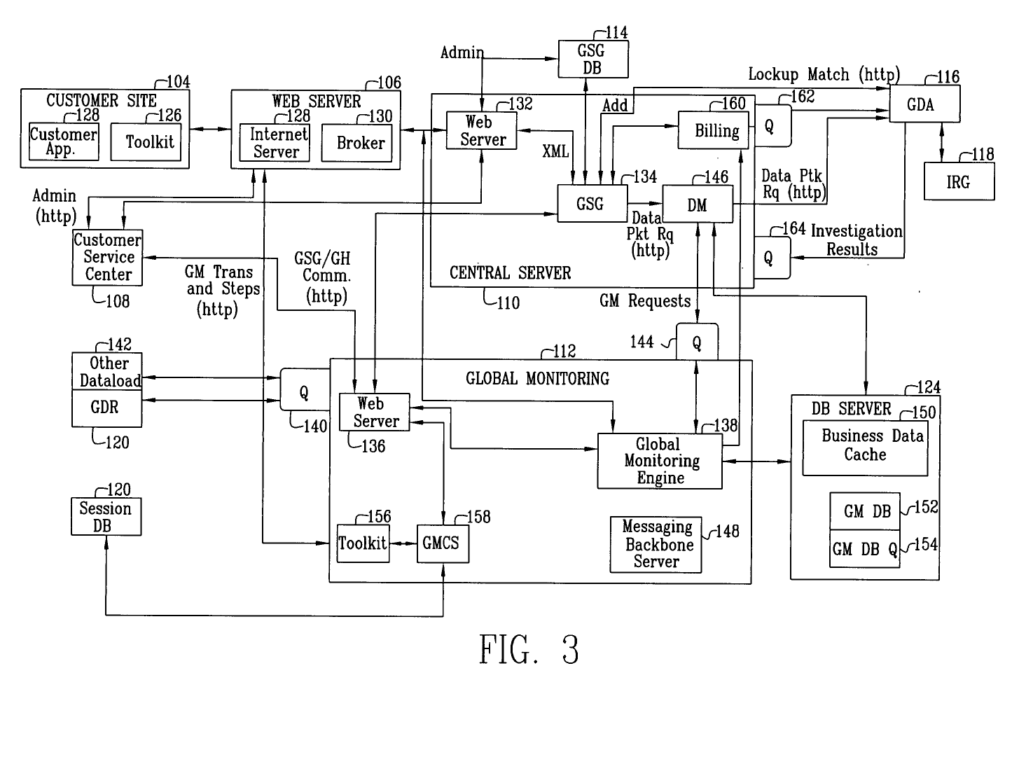

FIG. 3 shows the architecture of the monitoring system according to the present invention in more detail than FIG. 2. At customer site 104, a user uses a toolkit 126, which is XML, Java, or COM, and creates its own code in a customer application 128 to use the Internet to send and receive information from central server 110 via web server 106, which has an Internet server 128 and a broker 130. Web server 106 communicates with web server 132, which in turn communicates with a global service gateway (GSG) 134 in central server 110, passing along information. Global service gateway 134 is a Java application that coordinates the work to fulfill a request and then sends a response back to the customer through the same path the request traveled forward on. To do monitoring, global service gateway 134 interacts with various other system components.

In the case of an add registration request, the user wants to register a subject with monitoring system 102 to be monitored. Global service gateway 134 communicates with a web server 136 in global monitoring component 112 and then to global monitoring engine 138. Global monitoring engine 138 has a database queue 140 to interact with a data feed 142 and global data repository (GDR) 120 and database queue 144 to interact with data manager (DM) 146 in central server 110. Global monitoring engine 138 gets triggers, which are like notes to tell monitoring system 102 that there may have been a change in the data for a given subject. So, if somewhere in the world, somebody makes a change to a database, say a telephone number has changed for a business, that results in a record flowing to global data repository 120. Global data repository 120, in turn, sends a note to global monitoring engine 138 using messaging backbone server 148 to indicate that it is time to check on this company to see if there is anything that changed that is being monitored.

Global monitoring engine communicates with database server 124, such as a SQL server or an Oracle server, which has a business data cache 150, a global monitoring (GM) database 152, and a global monitoring (GM) queue (Q) 154. Global monitoring database 152 is the place where monitoring system 102 keeps track of what the current knowledge is about a given subject. Whenever new data comes in, it is compared against what is already known to see if any change has occurred. Global monitoring database 152 is a time series database so it has a history of values for any given data element. Global monitoring database 152 also stores the details about what cases are registered to be monitored. If a user established a registration on a business and then the business moved, global monitoring database 152 would have the old address until monitoring system 102 recognized the move. When the new address is updated in a regional database, a processor for that database forwards data to global data repository 120. Global data repository 120, in turn, sends a non-specific trigger to global monitoring engine 138. Global monitoring engine 138 does not yet know why it was triggered, but makes a request to get the current data for the business. The request to get the current data goes through queue 148 and then data manager 146 pulls it from there.

Data manager 146 may be combined with global service gateway 134. Data manager 146 obtains a full set of data, including the new address and sends a copy of it to queue 148 and to business data cache 150. Then, global monitoring engine 138 reads it from queue 148 and determines that the business' address has changed by comparing it to the old address in global monitoring database 152. Because a change is detected for an active registration, global monitoring engine 138 makes note of that in global monitoring database 152. Global monitoring database 152 also has information about which users are registered to monitor which subjects. Once the user who is monitoring this business is identified, a notification is stored so that it is ready for the user when the user comes and retrieves it.

When customer application 128, through toolkit 126, sends a get-notification request, it comes through web server 132 to global service gateway 134 and to web server 136 in global monitoring component 112 to global monitoring engine 138. Global monitoring engine 138 looks at global monitoring database 152 and checks what notifications are ready for the user based on criteria in the get-notification request. For example, a user may want only notifications it has not seen before or ones that are from today or the last three days or whatever notifications the user wants. Global monitoring engine 138 selects the appropriate notifications, retrieves them, and fabricates XML as a response. Global monitoring engine 138 returns the XML to global service gateway 134, which returns a response to the user as a level 2 notification. If it were level 3, then global service gateway 134 supplements the information being returned and communicates with data manager 146 to request the underlying data that had been originally provided on data feed 142. When data manager 146 first obtains the data from global data access 116 it stores a copy in business data cache 150. That copy is kept so that when the user retrieves notifications, global service gateway 134 can ask data manager 146 for the data to be used to fabricate a product.

Toolkit 156 in global monitoring component 112 is a Java toolkit used to host customer service center 108 and global monitoring customer service (GMCS) 158 is an application that uses toolkit 156 to direct requests back into a normal flow of transactions. Global monitoring customer service is a more powerful version of toolkit 126 at the customer site 104 to enable a customer service representative to perform operations on behalf of any user as well as across users. Messaging backbone server 148, such as IBM MQ series enables queue 148 and queue 140. Global data repository 120 also uses messaging backbone server 148.

Central server 110 includes web server 132, global service gateway 134, data manager 146, and a billing component 160, which comprises a plurality of billing systems, such as regional batch billing systems. Global monitoring engine 138 creates charges for billing component 160, such as charges for a group of files in global monitoring database 152. Billing component 160 communicates via a queue (Q) 162 or via file transfer protocol (FTP) to global data access 116 and global data access 116 communicates via another queue (Q) 164 with central server 110 for investigation results.

Data manager 146 accesses global data access 116 which accesses inter-regional gateway 118 to obtain data about a subject. When data manager 146 obtains data from global data access 116, it maintains business data cache 150 with the most recent copy of the business data for that subject whenever data manager 146 obtains data from global data access 146, it also sends the data feed into queue 144 for evaluation of whether the case is being monitored and whether data change has occurred. If global monitoring engine 138 detects a change and that change is associated with a level 3 notification, then global monitoring engine 138 notifies data manager 146 to keep the supporting data in business data cache 150 for an extended period of time. Otherwise, it would be subject to purge within a short time, such as a couple of days.

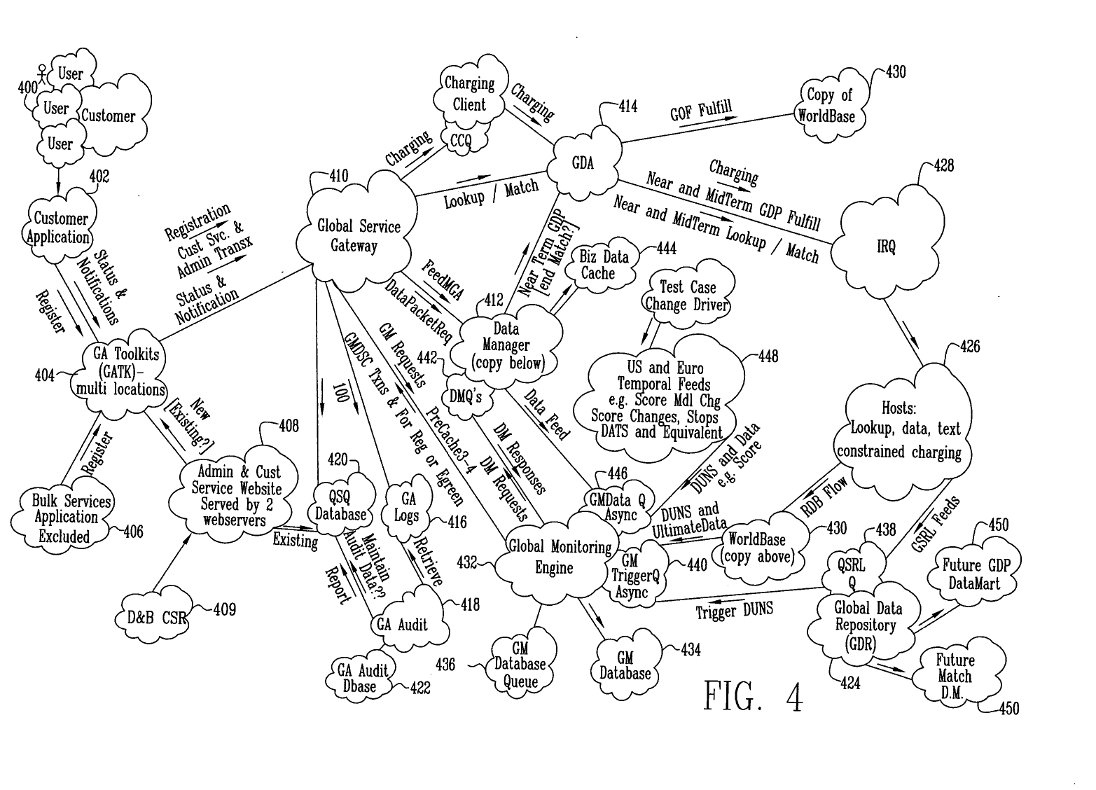

FIG. 4 shows methods for providing a monitoring service according to the present system. FIG. 4 is a context diagram that shows logical flow, not necessarily physical components. A user 400 uses a customer application 402 communicates through a global access (GA) toolkit (GATK) 404. A bulk services application 406 and an administrative and customer service website 408 for use by customer service representative 409 are also shown.

Toolkit 404 is an application that interacts with monitoring system 102 through a Java XML or COM toolkit, preferably an XML toolkit. Toolkit 404 interacts with global service gateway (GSG) 410. Data manager 412 interacts with global data access (GDA) 414. Some transactions do not go through data manager 412, and go directly to global data access 414 from global service gateway 410, such as lookups to locate a subject. Basically, when a user registers a subject to be monitored, the user has already performed a lookup and identified case identification numbers. There is logging 416, auditing 418, and a database 420 for global service gateway 410. Auditing 418 also has a database 422.

Global data repository (GDR) 424 communicates with hosts, Lookup, data, text, and constrained charging 426. Charging is supported via files transferred directly to billing systems to accommodate the high volumes normally associated with monitoring systems. Host databases 426 are the data centers. For example, the US is a data center a European data center and an Australian data center all have there own regional or national databases. And those are the same databases by and large that inter-regional gateway 428 communicates with when it has a request for data about a specific subject. Inter-regional gateway 428 basically sends that data back to global data access 414. WorldBase database is similar to global data repository 424 with respect to the fact that when a change occurs in the regional database for a given subject, a global standard record layout (GSRL) is forwarded to each global system. When a user is monitoring a business that moved host databases 426 are involved. Host database 426 notifies global data repository 424 about the change and creates a GSRL. Host database 426 creates a GSRL and forwards it to global data repository 424 using queuing or creating a file and transferring the file, depending on the country.

If user 400 is adding a registration or any other global monitoring (GM) request, user 400 sends the request through toolkit 404 to global service gateway 410. After receiving it, global service gateway 410 authorizes user 400 by looking at GSG database 420. Once global service gateway 410 checks the sign-on information and that user 400 had indeed paid for a license to do monitoring work, it then forwards the add registration request to global monitoring engine 432. Global monitoring engine 432 checks global monitoring (GM) database 434 to find a registration for user 400 with a case identification number in the request and for a set of elements defined by a product in the request. If a duplicate is found, it is rejected. Assuming that it is not a duplicate, global monitoring engine 432 makes note of the fact that user 400 wants to monitor this given subject. As part of this transaction, global monitoring engine 432 also determines whether global monitoring database 434 already has information about that subject, because another user is already monitoring that subject.

If global monitoring database 434 already has data about that subject, it immediately activates the registration and responds back through global service gateway 410 to user 400 with not only an acknowledgment, but also a confirmation that the registration is active. If the subject is not found in global monitoring database 434, then the registration is accepted and an acknowledgement that the registration is in a pending status is sent to user 400. Global monitoring engine 432 still needs to obtain the data on the subject. But pending retrieval of data, user 400 is notified that add registration request is complete, before the registration is activated.

Global monitoring engine 432 communicates with global service gateway 410 with the acknowledgement to say registration has been either rejected or accepted and is either in a pending or active state. Global service gateway 410 passes the acknowledgement to global access toolkit 404. After logging the results of the transaction in global access log 416, the acknowledgement is forwarded to customer application 402. Customer application 402 does whatever the user desires with the acknowledgement. At the same time that global monitoring engine 432 is carrying out this transaction, global monitoring engine 432 puts a request for the data about that subject into global monitoring queue 436. The product identified in a request defines a set of elements that user 400 is interested in monitoring and about which user 400 receives notifications. It also indicates the price that user 400 is charged. Bulk services application 406 receives a list of request, such as an add registration request and processes it on behalf of user 400 one at a time using the same process.

After user 400 has registered, a trigger is received by global monitoring engine 138 indicating that something may have changed about a subject. This occurs because host database 426 sends a GSRL to the global data repository 424 via a queue 438. Global data repository 424 sends a trigger with a case identification number, such as a DUNS number to a queue 440 for the global monitoring engine 432. Global monitoring engine 432 then reads queue 440 and for a majority of cases is likely to determine that no user 400 is monitoring it anyway and throws it away. But when it does, it matches a subject that a user 400 is monitoring. Global monitoring engine 432 sends a request to data manager queue (DMQ) 442. Data manager 412, in turn, retrieves data through global data access 414 and puts a copy into business data cache 444 and sends a data feed to a queue 446 for global monitoring engine 432. When global monitoring engine 432 receives in queue 446 that data on the subject, global monitoring engine 432 compares what it already knew about the subject from its database entries with what it just received in queue 446 to detect a change and make a note of it database 434 appropriately. But, user 400 is not notified then.

User 400 later uses toolkit 404 to interact with global service gateway 410 sending a get notification request. The get notification request is forwarded to global monitoring engine 432. Global monitoring engine 432 checks in its database 434 and determines if anything fits the criteria to return to user 400 in terms of notifications. Global monitoring engine 432 fabricates a response, which is a level two response regardless of what type of registration it was. Global monitoring engine 432 returns that as a notification response to global service gateway 410. Global service gateway 410, in turn, detects any level three registration for which notifications are included in the get notification response. If there is a level 3, global service gateway 410 requests data through data manager 412. Data manager 412 retrieves data from business data cache 444 and returns it to global service gateway 410, which fabricates the product. The product is inserted into the response that global service gateway 410 had received from global monitoring engine 432 and returns the whole thing back to user 400. So, there may be, for example, 50 products fabricated within that response if 50 registrations experienced data changes in one or more elements and if all the registrations were level three.

The get notification request may specify unread if the user only wants to receive things that it has not received previously. Something that is being delivered to the customer is not marked as having been read until customer application 404 comes back and acknowledges that it has processed it. Once the notification is received back from user 400, it is marked as having been processed.

Other kinds of data feeds flow into data monitoring engine 432. A sweep type operation on host databases 426 may cause a data feed. For example, if credit scores across many subjects are re-calculated in a host database. Rather than pulling a record for each monitored subject, a request is made for a copy of every modified score and DUNS number at one time passed into data feed 446 so global monitoring engine 432 quickly evaluates them. Global monitoring engine 432 ignores most of the data feeds, except subjects that are being monitored. Another example is a score model change from US and European temporal feeds 448, which includes stops, DUNS audit trail system (DATS), and equivalents. Stops indicate a problem with the data about a subject. Sometimes a subject is put on stop, which means it is not to be published an investigation is performed and data quality is ensured. If a DUNS number was created as a duplicate, it may be deleted by DATS and data may be transferred to another DUNS number. So that kind of information is handled and fed in to queue 446 for global monitoring engine 432.

Access from a datamart 450 built from global data repository 424 communicate with data manager 412. Instead communicating with global data access 414 for data, data manager 412 communicates with datamarts 450 to get data much more quickly. It is quicker because datamarts 450 are global in nature. They have data on every subject worldwide. So data manager 412 gets data from one global database rather than checking the different regional databases. On a per DUNS number basis, having to determine which host data center to contact and communications issues and translation of protocols between systems, etc. all slow down data manager 412 without datamarts 450. Whether any user 400 is monitoring a subject or not, datamart 450 has data about it.

Global data packet (GDP) flows between global data access 414 and global service gateway 134. Global data packet refers to a set of data that is handled at a global level by global service gateway 410 and by toolkit 404. Physically it is two data packets, a global data packet (GDP) and a global ownership packet (GOP). There are two separate data sources for the global ownership packet and the global data packet. Global data access 414 communicates with WorldBase 430 for global ownership packet, because WorldBase has globally rationalized and integrated ownership data. It communicates with inter-regional gateway 428 for the global data packet. Near and midterm GDP fulfillment and near and midterm lookup requests flow between inter-regional gateway 428 and global data access 414. The reason that they are near and midterm as opposed to long-term is because a datamart will be used to provide that data more efficiently in the future.

Other registration-oriented transactions occur, such as a get registration activities transaction. The logic flow is similar to the get notifications transaction, except that a product is never fabricated and inserted into the response and the information provided in the response is about registration activities, rather than subject data changes. For example, user 400 wants to know what registration activity happened to user's 400 registration today and a response would describe activity, such as renewed these ten, changed these five from pending to active, failed this one because the DUNS number was not found, and cancelled another one. For a cancel registration request, a user 400 through customer application 402, through toolkit 404, submits a modify registration request with a flag of cancel set. The request is passed to global service gateway 410, which passes it along GM requests to global monitoring engine 432. Global monitoring engine 432 determines the appropriate registration or perhaps registrations for multiple registrations. An example of multiple registrations to cancel is to cancel all user 400's registrations in Canada. Then many registrations are cancelled as the result of one transaction. An example of criteria is to exclude DUNS number and simply include country, the example of Canada, or maybe Canada and the US. Then, global monitoring engine 432 checks database 434 and determines what registrations for this user are associated with the specified countries, Canada and the US. For example, a list of ten thousand are cancelled. The registration status is set to cancel for all of them and a response to indicate cancellation is complete is sent to user 400.

There are many example methods or use cases according to the present invention. One use case is when user submits a registration for a case to be monitored. A precondition is that the profile associated with user must allow access to monitoring service. A successful end condition is successful registration of the case and a charge for the registration. The primary actor is customer application. (1) The user submits registration request with the following criteria: DUNS number of case (required), data product name (required), notification output level (required), country case (required), endorsement, an account identifier, an expiration date, and indication yes or no for evergreen. The request is authorized. User identification and password are verified. User profile is checked for access to monitoring service and the data integration product. The country for the case is checked against the user's permissions. Subscriber validation is performed. Case identifier (DUNS) is validated by MOD 10+5 check. Requested registration is checked against existing registration for duplicates. The combination of DUNS, user identification, product, notification level, and account identifier (even if null), must be unique. Also, the combination of user identification, product notification level and account identifier (even if null) must be unique. A check is made to see if the target subject is already being monitored. Registration request is recorded with pending status. Registration response which indicates that the registration status is pending is fabricated and returned to the user. The user transaction is complete. Baseline data is requested for the subject DUNS both with and without trade-up to headquarters. Data is returned. It is confirmed that the subject is not a branch. Returned country is equal to supplied country. Case status is verified as being normal. Data sufficiency is verified per existing data integration standards for the data product included in the registration request. Baseline data is saved. Registration status is changed to active. Customer is charged for monitoring registration unless it was previously charged.

Another use case is system receives trigger. The goal in context is that the system generates a data request if there is at least one active registration on the DUNS in trigger. A precondition is that the source of triggers exists. A successful end condition is that the data request is forwarded to a data source for fulfillment. The monitoring engine receives the trigger represented by a text document containing DUNS, source database date, information source, SD indicator, DATS delete indicator, DATS transfer indicator, and DATS destination DUNS. Trigger's DUNS is used to identify registrations. Data is requested for all subject DUNS which are part of the registration identified.

Another use case is system receives data feed. The goal in context is that for actively monitored cases, the system saves all changes to monitorable data element values. For all active registrations, the system creates pending notifications. For pending registrations, a baseline of all data element values is established. A successful end condition is notification(s) and changed data elements are saved, baseline is established, or data feed is discarded. The trigger is all data feeds triggered indirectly, such as GSRL trigger, on-line product order, or pending registration. The monitoring engine receives a data message containing DUNS and element names and values. At least one active registration exists that is monitoring the DUNS number. Data message is verified to be more recent than the last data message of this type (GDP or GOP) for subject DUNS. The data feed indicates that the DUNS number is active. Discover changes in data values of monitorable elements. Save data element value changes and date. For each registration with an interest in the changed data elements, mark for future notification delivery.

Another user case is user requests notifications. The goal in context is data integration user's toolkit application requests notifications. The precondition is data integration user's profile allows access to monitoring service. A successful end condition is data integration user successfully received notifications or receives message back indicating no changes. Notifications changed to read, from unread, where applicable. The primary actor is the customer's data integration toolkit application. The user requests notifications. The following are valid criteria for notification requests. Along with the action parameter mark notification (mark as read, leave unread) any/all of the following criteria can be used in combination, except where noted: data product name, notification output level, customer account identification, DUNS of case, customer endorsement, user or customer (all sibling) indicator, pending only or not (pending indicates unread), notifications associated with active registrations only, country of case, date range of notification creation, and data range of notifications previously delivered (cannot be used with pending flag on). Data integration user identification and password is authorized. Note that user's product profile is not checked for access to the monitoring service because current user permission with respect to monitoring may not reflect the fact that a user previously had access to monitoring. Request is validated. It is determined if any notifications fit the criteria. It is confirmed that the result set size is small. Notifications are fabricated and returned to the user. Mark or nomark directive is applied for the entire result, regardless of user.

Another use case is user requests registrations list. The goal in context is that data integration user's toolkit application requests registrations. A successful end condition is registrations matching input criteria are returned. The primary actor is the customer's data integration toolkit application. The user submits query with the following optional parameters: DUNS of case, country of case, customer endorsement, customer account identification, data product name, notification output level, user or customer (all sibling) indicator, registration renewal date range, registration expiration date range, registration status (active, pending, failed, deactivated, cancelled, expired), and registration activity (changes in registration status) date range. Data integration user identification and password are authorized. Note that the user's product profile is not checked for access to the monitoring service because the current user permission with respect to monitoring may not reflect the fact that a user previously had access monitoring. It is determined if any registrations fit the criteria. It is confirmed that the result set size is small. Return results to user: business name, data product name, notification output level, customer account identification, DUNS of case, country of case, customer endorsement, registration status (active, pending, failed, deactivated, cancelled, expired), registration renewal date, registration expiration date, and registration last activity date.

Another use case is user requests registration activity. The goal in context is that data integration user's toolkit application requests registration activity. The successful end condition is registration activity matching input criteria is returned. The primary actor is the customer's data integration toolkit application. User submits query with the following optional parameters: data product name, notification output level, country of case, customer account identification, DUNS of case, customer endorsement, activity code, activity date range, expiration date range, return unread activity only, action parameter or directive level activity marked as unread, registration status (pending, active, failed, deactivated, cancelled, expired), and user's level. Request is authorized. Data integration user identification and password are verified. Note that user's product profile is not checked for access to the monitoring service because current user permission with respect to monitoring may not reflect the fact that a user previously had access monitoring. It is determined if any registrations fit the criteria. It is confirmed that the response does not exceed response size or time thresholds. Return results to user, including the following: business name, data product name, notification output level, customer account identification, DUNS of case, country of case, customer endorsement, registration status (active, pending, failed, deactivated, cancelled, expired), registration renewal date, registration last activity date, and profile name (combination of product name and level).

Another user case is user modifies registration (or cancels or reverses cancellation of registration). The goal in context is that data integration user's toolkit application modifies registration. A precondition is that registrations exist for this user. A successful end condition is that data integration user has successfully modified a registration. The primary actor is the customer's data integration toolkit application. User submits registration modification request with the following criteria: DUNS of case (required), data product name (required), notification output level (required), customer account identification (optional). Including new values in the request can update or cancel or uncancel the following registration attributes: customer endorsement, registration expiration date, registration renewal date, customer account identification, new automatic renewal indicator. Request is authorized. Data integration user identification and password are verified. Note that user's product profile is not checked for access to the monitoring service because current user permission with respect to monitoring may not reflect the fact that a user previously had access monitoring. Check that registration exists. Verify the modified registration will be unique. Registration is modified. Confirm back to user that modifications have been made by including the following in the response: DUNS of case, data product name, notification output level, customer account identification, customer endorsement, registration expiration date, registration renewal date.

Another use case is user cancels registration. The goal in context is that the data integration user's toolkit application cancels a registration. A precondition is that registrations exist for this specific user. A successful end condition is that the data integration user has successfully cancelled a registration. The primary actor is the customer's data integration toolkit application. Data integration user submits a modifying transaction to cancel a registration request with the following criteria: DUNS of case (required), data product name (required), notification output level (required), customer account identification (optional), and cancel registration Indicator (required). Authorize request by verifying Data Integration User identification and password. Note: User's product profile is not checked for access to the Monitoring service because user permission with respect to Monitoring may not reflect the fact that a user previously had access to Monitoring. Verify an active, failed, deactivated or pending registration already exists. Change registration status to cancelled and save date of cancellation. Confirm to the User that the cancellation request has succeeded by returning a successful result code and the following: DUNS of case (required), data product name (required), notification output level (required), customer account ID (optional), registration expiration date, registration renewal date.

Another use case is user reverses registration cancellation, which is part of modifying at present i.e. not a separate transaction. The goal in context is that data integration user's toolkit application reverses a registration cancellation. A precondition is that a cancelled registration exists for this specific user. A successful end condition is that data integration user has successfully reversed a registration cancellation. The primary actor is the customer's data integration toolkit application. Data integration user submits an uncancel registration request using a modifying transaction with the following criteria: DUNS of case (required), data product name (required), notification output level (required), customer account ID (optional), and uncancel Registration (required). Authorize request by verifying data integration user identification and password. Note: User's product profile is not checked for access to the Monitoring service because user permission with respect to Monitoring may not reflect the fact that a user previously had access to Monitoring. Verify a cancelled registration meeting above criteria exists. Change registration to active status. Verify original registration renewal date is in the future. Confirm back to the User that the cancellation reversal request has succeeded by returning a successful result code and the following: DUNS of case (required), data product name (required), notification output level (required), customer account ID (optional), registration expiration date, registration renewal date.

Another use case is system receives case identifier change—DATS/DUNS number delete. The goal in context is that the system deactivates all registrations on deleted DUNS and notifies users with active registrations of the cancellation. A precondition is that the system will receive DUNS number deletions. A successful end condition is that the system saves deletion and customer is informed of deletions to their actively monitored cases. The primary actor is the regional/global data gathering systems. The trigger is when a DUNS number for a case is deleted as a result of D&B data gathering process. Trigger source forwards to the System a DUNS number and a deletion indicator. For each active registration referencing this DUNS, modify registration status to deactivated. For each pending registration referencing this DUNS, modify to failed. For each registration that had a status change, create a registration activity. Change the subject status for this DUNS to deactivated.

Another user case is system receives trigger on deactivated case (Implied Reinstatement). The goal in context is that the system reverses de-activation i.e. it is assumed the trigger represents an implied re-instatement. A precondition is that the system will receive trigger on cases that were previously identified as deleted. A successful end condition is that the system re-activates registrations and notifies appropriate users. The primary actor is the regional/global data gathering systems. The trigger is receipt of trigger on previously deleted case. System verifies there is a deactivated subject for DUNS in the trigger. Reactivate the subject (change subject status to “active”). For each registration with a status of “deactivated” which references the newly reactivated subject, change the registration status to “active” and create a “Subject Reactivated” registration activity. (The nightly renewal will pick up active registrations and renew or expire them appropriately, depending on dates). Request data update for restored case.

Another user case is system receives case status change to stop distribution. The goal in context is to prevent communications to customers of data about subjects that are on stop. The precondition is that the system will receive stop distribution triggers via GSRL and/or manual intervention. A successful end condition is that customers do not receive information about subjects on stop distribution until the stop is removed. The primary actor is the monitoring application. Stop distribution information is received. The subject status is marked “unavailable”. As a result, related notifications are put on hold. If any “pending” registration exists for the subject, add a registration activity indicating that it is pending, and awaiting removal of stop.

Another use case is user transfers registration. The goal in context is that data integration user's toolkit application transfers registrations from one user (transferor) to another (transferee) within the same contract. A precondition is that registrations exist for the transferor. A successful end condition is that data integration user has successfully transferred a registration(s). The primary actor is the customer's data integration toolkit application. The Data Integration User who is to receive the Registrations submits a registration transfer request. Request must contain the following information: user identification and password of the intended new owner of the registrations, user identification and password of the current owner of the registrations, DUNS (optional), product being monitored, subject country, notification level (optional), account ID where applicable, cancel duplicate registration indicator. Request is authorized: Both user identifications and passwords are verified, transferee User's product profile is checked for access to the Monitoring service, the Data Integration product and the User country access is checked. Check that both of the Users are from the same billing country. Check that both of the Users have the same Test/Production status. Check that both of the Users belong to the same contract. Identify Registrations that fit the criteria. The status of the Registration is irrelevant i.e. inactive, deleted, etc. Transferred Registration is checked against the existing Registration for duplicates. The necessary modifications are made to effect the transfer of any non-duplicate Registrations by the Monitoring system (this includes the transference of any pending notifications to the receiving user). Confirm back to the User that Modifications have been made.

Another use case is billing procedure. The goal in context is correct billing applied to registrations. A precondition is that registrations are eligible for payment. A successful end condition is that eligible registrations are charged. The primary actor is the monitoring application. The trigger is normal billing scheduled daily, with retry scheduled several times throughout the day to reprocess any past chargeable activities or file transmissions not yet billed. Obtain a copy of D&B Contract data from the GSG database (e.g. User identification vs. Subscriber info and internal/test status). Identify all outstanding (no charge previously transmitted) chargeable activities associated with registrations, such as activation or renewal. Extract appropriate data related to the activities identified above. Billing Product Code and Subject Country Code schemes are billing center specific. For each Billing Center with identified activities, create a batch row to group the charges for this run. For each chargeable activity per Billing Center, create a Charge Item row in the database and a Summary Charge row. Link the Summary Charge row to the Batch row created in the previous step. (Currently, a Summary Charge row is created for each Charge Item row. In the future, it would be possible to support summarization of n charges for a given billing product code and chargeable user. At this time, the direction is for billing centers to retain responsibility for any desired summarization, ensuring their ability to capture any necessary details.) After creation of the last Charge and Summary Charge row per billing center is complete, mark the corresponding Batch row “ready to xmit”, mark the original chargeable activities as “processed” (so that they are no longer “outstanding”), and commit the database updates. Repeat the steps “For each Billing Center” through the previous step, for each Billing Center with identified chargeable activities prior to moving to the next step. Identify all Batch rows which are “ready to xmit”. Where multiple Batch rows have been identified for the same Billing Center, link the Batches together via the Superceded link. Update the latest (or only) Batch row for the Billing Center with the file name to be created during this process for that Billing Center. For each Summary Charge associated with the Batch (or linked Batch rows), write an appropriately formatted record to the file for this Billing Center. Close the file. If the Billing Center Transmission Details indicate a need to confirm that the remote file exists and is empty, do so. Transmit the file according to the appropriate Billing Center Transmission Details. Currently, FTP is supported. If the Billing Center Transmission Details indicate a need to confirm that the remote file was not corrupted during the transmission, do so. If the Billing Center Transmission Details indicate a need to rename the remote file so that it may be processed by the billing center, do so. Update and commit the Batch row(s) for the Billing Center to indicate that transmission is complete. Repeat the “Where multiple Batch rows . . . ” step through the previous step for each Billing Center in the identified “ready to xmit” Batch rows. In each billing center, a process will pick up the remote file and start the process to bill the customer appropriately. That process will do any work necessary to clean out or remove the remote file. Currently, no feedback loop to the GME database has been established. Such a feedback loop would enable reconciliation of transmitted charges.

It is to be understood that the above description is intended to be illustrative and not restrictive. Many other embodiments will be apparent to those of skill in the art upon reviewing the above description, including changes in parameters, the number of parameters, or changes in the composition of operations or the order of operations or how operations are performed and other changes. The present invention has applicability to data processing and database applications outside the business information industry. Therefore, the scope of the present invention should be determined with reference to the appended claims, along with the full scope of equivalents to which such claims are entitled.

What is claimed is:

1. A method of providing a monitoring service, comprising:
receiving an add registration request from a customer application to register a case, said add registration request comprising a case identification number, a data product name, and a notification level;
registering said case by storing baseline data for said case and setting a registration status for said case to active;
monitoring said case by detecting data changes; and
providing a notification of said data changes.

2. The method according to claim 1, further comprising;
receiving additional add registration requests from said customer application to register additional cases;
wherein a portfolio of cases is created by registering each of said additional cases in said portfolio.

3. The method according to claim 1, further comprising:
charging for said add registration request.

4. The method according to claim 1, further comprising:
sending a response to said customer application indicating a pending registration status, before registering said case.

5. The method according to claim 1, further comprising:
authorizing said add registration request by checking a user profile associated with said customer application for access.

6. The method according to claim 1, further comprising:
validating said case identification number.

7. The method according to claim 1, wherein monitoring said case by detecting data changes comprises:
receiving an update on a subject;
determining that said subject is part of said registered case; and
storing update data for said subject for future notification delivery.

8. The method according to claim 7, wherein providing a notification of said data changes comprises:
receiving a notification request from said customer application, said notification request comprising said case identification number, said data product name, and said notification level;
fabricating a notification based on said update data; and
making said notification available to said customer application.

9. The method according to claim 8, wherein said notification level is one; and wherein said notification comprises a tag of an element that has changed.

10. The method according to claim 8, wherein said notification level is two; and wherein said notification comprises a tag of an element that has changed and a value of said field.

11. The method according to claim 8, wherein said notification level is three; and wherein said notification comprises a tag of an element that has changed, a value of said field, and a data product.

12. The method according to claim 1, further comprising:
receiving a get-registration request from said customer application, said get-registration request comprising criteria; and
providing information about said registered case if said registered case matches said criteria.

13. The method according to claim 12, wherein said criteria is a registration status.

14. The method according to claim 1, further comprising:
receiving a registration activity request from said customer application, said registration activity request comprising criteria; and
providing information about said registered case if said registered case matches said criteria.

15. The method according to claim 1, further comprising:
receiving a modify registration request from said customer application, said modify registration request comprising said case identification number, said data product name, said notification level, and a modification instruction; and
modifying said case according to said modification instruction.

16. The method according to claim 1, further comprising:
receiving a cancel registration request from said customer application, said cancel registration request comprising said case identification number, said data product name, and said notification level;
changing said registration status to cancelled; and
confirming cancellation to said customer application.

17. The method according to claim 16, further comprising:
receiving a reverse registration cancellation request from said customer application, said reverse registration cancellation request comprising said case identification number, said data product name, and said notification level;
changing said registration status to active; and
confirming cancellation reversal to said customer application.

18. The method according to claim 1, further comprising:
receiving notice of a deleted case identification number; and
changing said registration status to deactivated for said case and making a registration activity notification available to said customer application, if said case identification number equals said deleted case identification number.

19. The method according to claim 18, further comprising:
receiving notice of reinstatement of said previously deactivated case including a reinstated case identification number; and
changing said registration status to active for said case, if said case identification number equals said reinstated case identification number.

20. The method according to claim 1, further comprising:
receiving a stop distribution information for a subject; and
changing a subject status for said subject to unavailable; and
if said subject is part of said case, putting any notifications on hold.

21. The method according to claim 1, further comprising:
receiving a registration transfer request from said customer application to transfer from a current owner to a new owner, said registration transfer request comprising current owner login information and new owner login information;
authorizing said current owner login information and said new owner login information by checking profiles for access;
verifying said current owner and said new owner have some of a same billing information;
transferring ownership of said registered case from said current owner to said new owner; and
confirming transfer to said customer application.

22. A website, comprising:
a downloadable data-integration toolkit for communicating with a monitoring system for monitoring changes to business and financial information, said downloadable data-integration toolkit comprising:
a plurality of downloadable software components for building a customer application; and
a plurality of request formats for use by said customer application in communicating with said monitoring system.

23. The website according to claim 22, wherein said plurality of request formats comprises:
a format of an add registration request;
a format of a modify registration request;
a format of a registration transfer request;
a format of a registration activity request;
a format of a get-registration request; and
a format of a get-notification request.

24. The website according to claim 22, further comprising:
instructions for communications from said customer application to said monitoring system.

25. A monitoring system, comprising:
a web server capable of receiving a request from a customer application and sending a notification to said customer application;
a global service gateway capable of fulfilling said request and fabricating said notification;
a monitoring engine capable of detecting a data change and providing said data change for a subject with an active registration to said global service gateway for use in fabricating said notification;
a data repository capable of providing a change indication to said monitoring engine;
a monitoring database capable of storing registration information and providing baseline data to said monitoring engine; and
a data manager capable of providing update data to said monitoring engine and providing data to said global service gateway for use in fabricating said notification.

26. The system according to claim 25, wherein said notification includes a data product.

27. The system according to claim 25, further comprising:
a downloadable data-integration toolkit for facilitating creation of said customer application.

28. The system according to claim 25, further comprising:
a datamart built from a global data repository to provide data to said data manager.

29. The system according to claim 25, further comprising:
a customer service center capable of performing as said customer application.

30. The system according to claim 25, further comprising:
a billing system capable of charging a user for said customer request;
wherein said monitoring engine provides information to said billing system based on said registration information and said request.

31. The system according to claim 25, further comprising:
an inter-regional gateway capable of accessing a plurality of data centers in various regions; and
a global data access component capable of receiving business and financial data from said inter-regional gateway and providing said business and financial data to said data manager.

32. The system according to claim 30, further comprising:
a business data cache capable of storing data associated with said data change for use in fabricating said notification and providing said data to said data manager.
